(19) United States
(12) Patent Application Publication
(10) Pub. No.: US 2004/0247769 A1
(43) Pub. Date: Dec. 9, 2004

(54) Method and apparatus for treating meat, poultry, and fish with carbon monoxide or purified smoke

(75) Inventors: John Victoria, Washington, PA (US); Donald A. Kelley, Miami Beach, FL (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(73) Assignee: Western Edge, Inc.

(21) Appl. No.: 10/454,722

(22) Filed: Jun. 4, 2003

(51) Int. Cl. A23L 1/31

(52) U.S. Cl. 426/641

(57) ABSTRACT

A vessel for treating meat with a vacuum and carbon monoxide or purified smoke comprises a cylindrical wall, a closed axial end and an open axial end, a door for closing the open axial end, a rack with plural shelf supports for supporting trays of means to be treated, horizontal guide rails fixed to opposite sides of the vessel interior enabling the rack to be slid through the door and onto the guide rails while loaded with meat to be processed, a port for connecting the interior of the vessel to a vacuum pump, and a second port for connecting the interior of the vessel to a source of carbon monoxide or purified smoke.

### BACKGROUND OF THE INVENTION

1. Field of the Invention

This application relates to methods and apparatus for treating meat, poultry, and fish with carbon monoxide or purified smoke.

2. Description of Related Art

Numerous patents disclose methods of treating meat (herein “meat” refers to meat, poultry, and fish) with a vacuum and carbon monoxide or purified smoke to preserve the freshness and appearance when frozen and unfrozen. See, for example, the following U.S. Pat. Nos. 2,965,494; 4,522,835; 5,972,401; 6,113,962; 6,270,829; and 6,521,275.

### SUMMARY OF THE INVENTION

Briefly, according to this invention, there is provided a method of treating meat, poultry, or fish in a vacuum/pressure vessel having means for evacuating the interior of the vessel and means for supplying a preserving gas atmosphere therein. The preserving gas may comprise a mixture of carbon monoxide and a filler gas, such as nitrogen, reducing gases, inert gases, and mixtures thereof. The vessel has a plurality of flexible conduits therein, one end of which terminates in a needle and the other end of which communicates through the wall of the vessel with a source of preserving gas, such as carbon monoxide or a blend of carbon monoxide and filler gas. The method comprises the steps of: a) placing the meat, poultry, or fish in the vessel with the needles penetrating into the surface thereof; b) closing and sealing the vessel; c) drawing a vacuum on the vessel; d) passing a preserving gas through the conduit and needles; e) after a period of time discontinuing the flow of preserving gas; f) evacuating the vessel; and g) allowing the vessel to be filled with atmospheric gases so that the vessel can be opened and unloaded. In a preferred embodiment, the vacuum is drawn on the vessel and preserving gas is supplied through the needles simultaneously. The preserving gas mixture may also be introduced directly into the vessel after the vacuum is drawn as well as through the needles.

Also, according to this invention, there is provided a vessel for treating meat with a vacuum and carbon monoxide or purified smoke comprising a generally cylindrical wall with a generally horizontal cylindrical axis, a closed axial end, and a door for closing the axial end which is opposite the closed axial end. The door, when opened, permits substantially unobstructed access to the entire cross section of the cylindrical interior of the vessel. A hanging rack with plural shelf supports support trays of meat to be treated. Horizontal guide rails are fixed to opposite sides of the vessel interior enabling the rack to be slid through the door and onto the guide rails while loaded with meat to be processed. The guide rails and a rack dolly support a plurality of ball transfers to accommodate this procedure. A first port connects the interior of the vessel to a vacuum pump. A second port connects the interior of the vessel to a source of carbon monoxide or purified smoke delivered into the vessel via the means of a control system and diffusers to tailor the input. According to one preferred embodiment, the vessel further comprises a plurality of multi-port manifolds assembled in series to comprise a master manifold. One or more master manifolds are mounted on the rack assembly depending on unit capacity. Each master manifold is in communication with a plurality of hollow needles and the respective flexible conduit extending from the master manifold comprising a needle system. The vessel has a needle port for connecting the needle system to a controlled and regulated source of carbon monoxide or purified smoke. At least one master manifold is connected to the needle port. The multi-port master manifold if configured for receiving a plurality of flexible conduit needle assemblies that could vary depending on production needs.

### BRIEF DESCRIPTION OF THE DRAWINGS

Further features and other objects and advantages will become clear from the following detailed description made with reference to the drawings in which:

FIG. 1 is a plan view of a vessel for treating meat according to this invention;

FIG. 2 is a back view of the same vessel;

FIG. 3 is a broken away plan view of the same vessel with the door in the open position showing the interior of the vessel including the diffusers that introduce gas into the interior and the connection details for the needle system;

FIG. 4 is a plan view of a dolly with the hanging rack position thereon in its travel position and with several trays positioned on the rack in the upper left-hand corner; and

FIG. 5 is an end view of the dolly shown in FIG. 4 illustrating a master manifold assembly.

### DESCRIPTION OF THE PREFERRED EMBODIMENTS

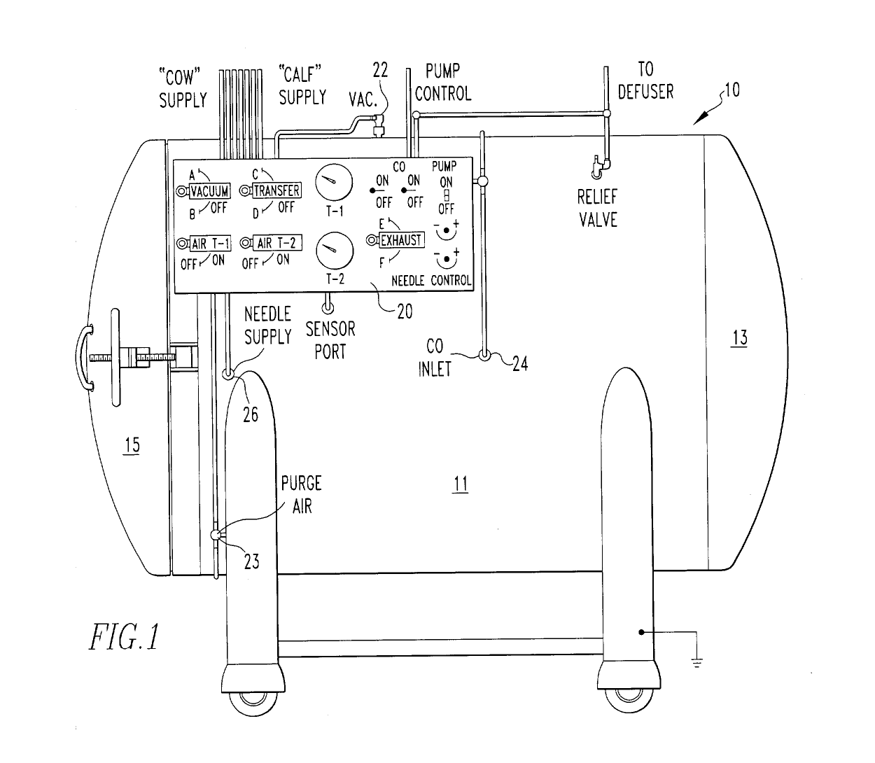

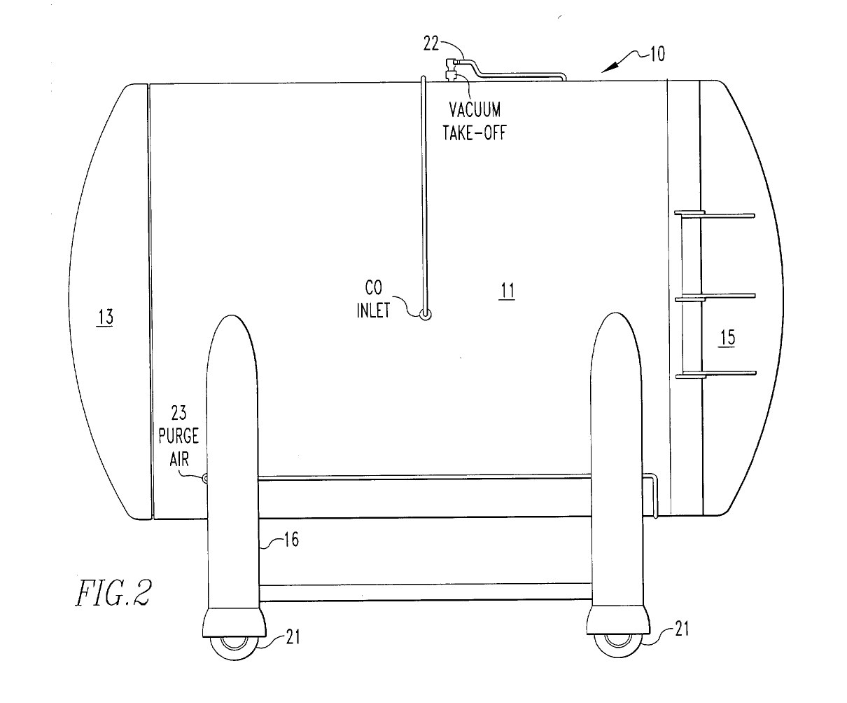

Referring now to FIGS. 1, 2, and 3, there is shown a cylindrical vessel according to the present invention for treating meat with a vacuum and carbon monoxide and purified smoke. The vessel 10 has a generally cylindrical wall 11 with an axis that is generally horizontal. As shown, the vessel is circular cylindrical, but this is a preferred embodiment. The vessel has a closed end 13 that may have a convex or spherical shape. Opposite the closed end is an open end 14. At the open end 14 is a door 15, which may also be convex or spherical, for air-tight and vacuum-tight sealing of the vessel 10. The door has a two-way pressure seal. The door seals are arranged to enable the vessel to be placed at a vacuum or pressurized without leaking. The door covers substantially the entire open end to allow maximum access to the interior of the vessel.

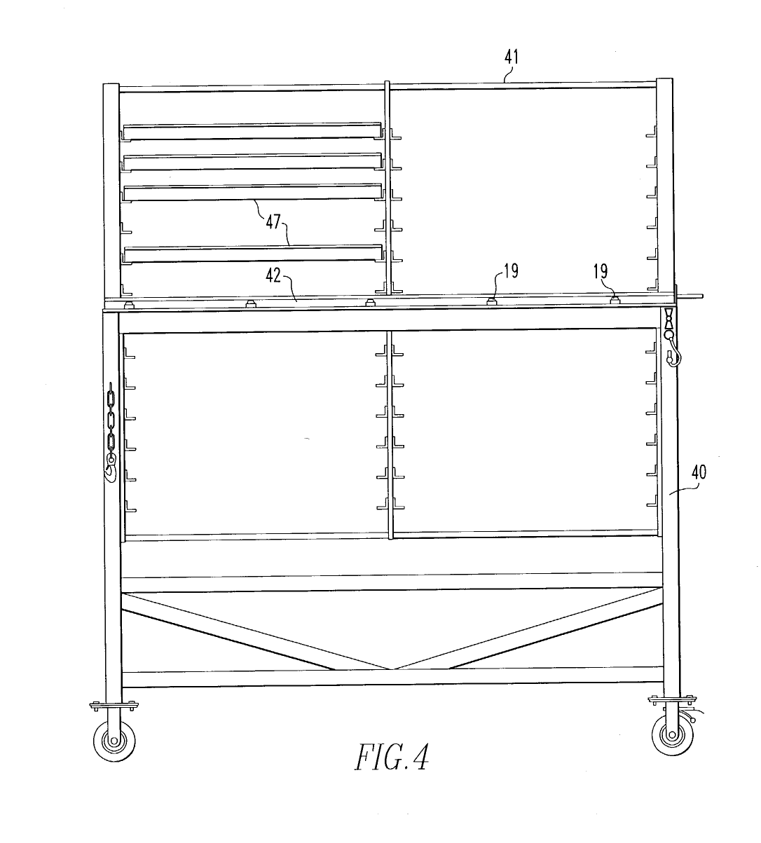

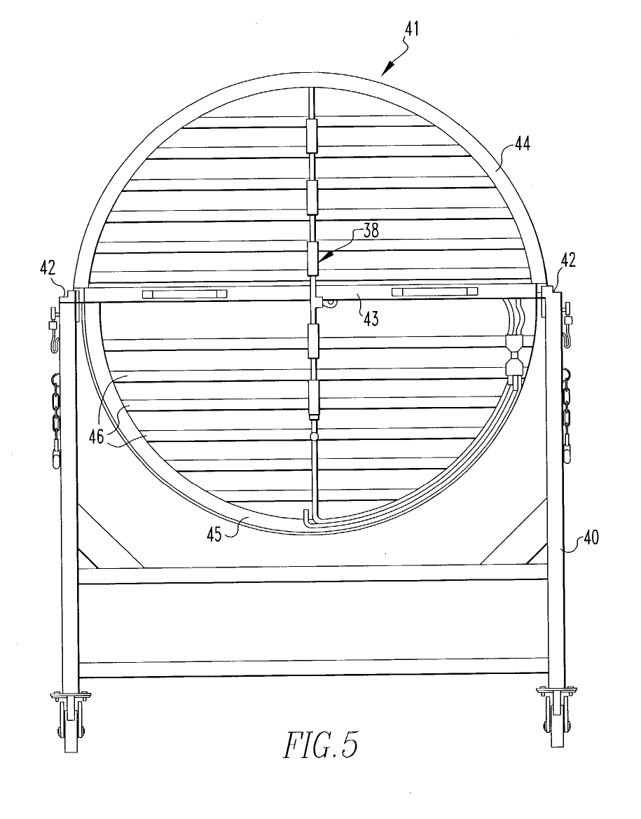

Guide rails 18 are mounted on each side of the vessel interior for supporting a hanging rack shown in FIGS. 4 and 5. On the guide rails are ball transfers 19. The vessel may be supported on a carriage 16 that has four casters 21 for moving the vessel 10.

As shown in FIG. 1, a control panel 20 mounted on the vessel 10 and automatically operated valves (not shown) enable pumping a controlled vacuum on the vessel, isolating the vessel from the vacuum pump, and applying treatment gases to the vessel as will be explained. Numerous control schemes are possible. The vessel has a number of ports with controlled valves including a vacuum take off port 22, purge air ports 23, treatment gas inlet ports 24, transfer port 25, and needle supply ports 26.

In one application of the vessel, a plurality of master manifolds 38 is shown in FIG. 5. Each master manifold is in communication with a plurality of hollow needles. There is a flexible conduit 30 attached to the master manifold in communication with the needle system with a quick disconnect fitting 32 on the end thereof.

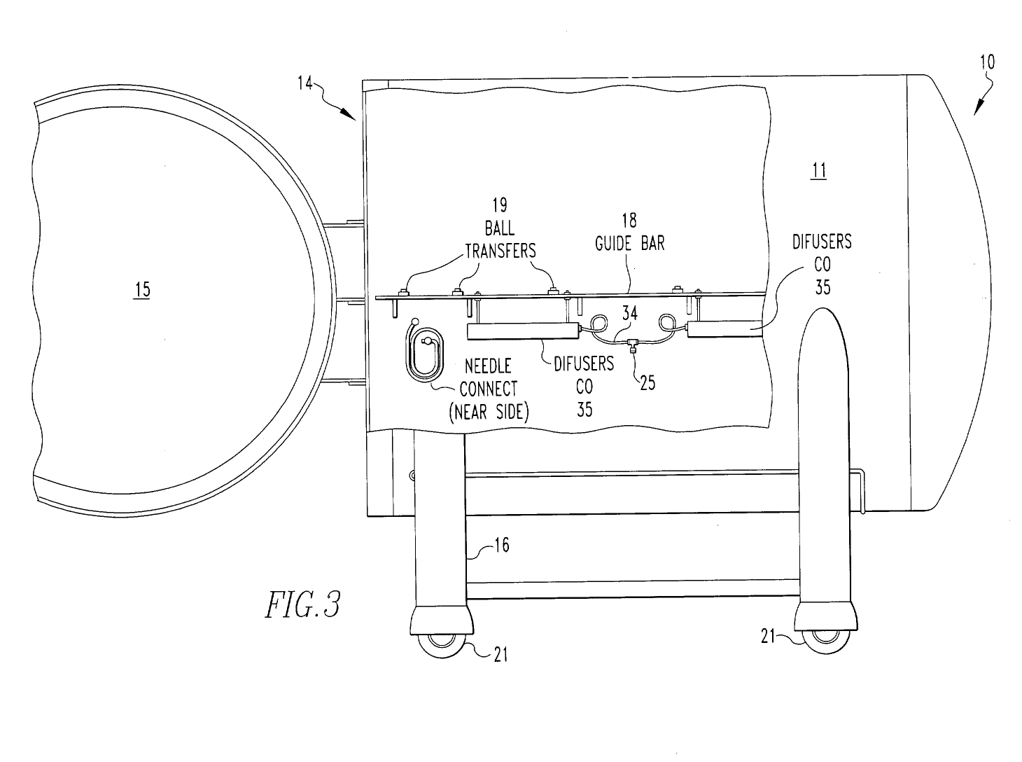

According to a preferred embodiment, the treatment gas inlet ports 24 have a conduit 34 connected thereto, the other end of the conduit being connected to diffusers 35 so that treatment gas can penetrate the entire interior of the vessel uniformly. As shown in FIG. 3, the diffusers 35 are hung from the guide rails 18.

Referring to FIGS. 4 and 5, a hanging rack 41 is shown outside of the vessel hung on a dolly 40. The hanging rack 41 has two parallel angle irons 42 for riding over the ball transfers 19 on the guide rails 18 inside the vessel 10 and ball transfers 19 supported by the dolly 40. Cross bars 43 connect the ends of the angle irons 42. Attached to the frame formed by the angle irons 42 and cross bars 43 are upwardly extending arches 44 and inverted arches 45. Supported by the frame and the arches are shelf supports 46 onto which trays of meat 47 can be placed.

One method of processing meat with the above described apparatus comprises placing pieces of meat (for example, filets or chops) on the trays and placing the trays on the rack while it is on the dolly. The racks are transferred to the interior of the vessel by sliding the rack off of ball transfers on the dolly and onto ball transfers on the guide rails. The vessel is then closed and sealed. A vacuum pump attached to the vacuum take off port is then activated to evacuate the vessel. According to a preferred method, a vacuum is maintained for a dwell time, say 15 minutes, in order to loosen the meat. Now the vessel is filled with treatment gas comprising CO and filler gas or purified smoke.

According to yet another embodiment of this invention, as the pieces of meat are placed on the trays, needles are inserted into the surface of the meat. As described above, the vessel is evacuated. After some delay, the treatment gas is simultaneously provided to the needles through the needle port and the master manifold. The negative pressure in the vessel and the positive pressure in the needles greatly enhance the penetration of the treatment gas into the meat.

One of the advantages of the apparatus, according to this invention, is that the treatment gas can be recovered from the vessel and reused. A pump connected to the transfer port can be used to recapture the treatment gas to be stored in a reservoir.

As used in the following claims the term “meat” means “meat, poultry, or fish”.

Having thus defined our invention in the detail and particularity required by the Patent Laws, what is desired protected by Letters Patent is set forth in the following claims.

The invention claimed is:

1. A vessel for treating meat with a vacuum and carbon monoxide or purified smoke comprises:
a cylindrical wall with a horizontal cylindrical axis;
a closed axial end and an open axial end;
a door for closing the open axial end, said door when opened permitting substantially unobstructed access to the entire cross section of the cylindrical interior of the vessel;
a rack with plural shelf supports for supporting trays of meat to be treated;
horizontal guide rails fixed to opposite sides of the vessel interior enabling the rack to be slid through the door and onto the guide rails while loaded with meat to be processed;
a port for connecting the interior of the vessel to a vacuum pump; and
a second port for connecting the interior of the vessel to a source of carbon monoxide or purified smoke.

2. The vessel according to claim 1, wherein the guide rails support a plurality of ball transfers.

3. The vessel according to claim 2, further comprising a plurality of master manifolds each having a plurality of flexible conduits extending from the master manifolds, said conduits terminating in hollow needles, said vessel having a needle supply port for connecting to a source of carbon monoxide or purified smoke.

4. A method of treating meat in a vacuum/pressure vessel having means for evacuating the interior of the vessel and means for supplying a preserving gas atmosphere therein, said vessel having at least one conduit therein in communication with a hollow needle and the other end of which communicates through the wall of the vessel with a source of preserving gas, said method comprising the steps of:
a) placing the meat, poultry, or fish in the vessel with said needle penetrating into the surface thereof;
b) closing and sealing the vessel;
c) drawing a vacuum on the vessel;
d) passing a preserving gas through said conduit and needle;
e) after a period of time discontinuing the flow of preserving gas;
f) evacuating the vessel; and
g) allowing the vessel to be filled with atmospheric gases so that the vessel can be opened and unloaded.

5. The method according to claim 1, wherein the vacuum is drawn on the vessel and preserving gas is supplied through the needle simultaneously.

6. The method according to claim 4, wherein the preserving gas is a mixture of carbon monoxide and a filler gas, such as nitrogen, reducing gases, inert gases, and mixtures thereof.

7. The method according to claim 4, wherein the preserving gas mixture is introduced directly into the vessel after the vacuum is drawn as well as through the needle.

8. The method according to claim 4, wherein the preserving gas is evacuated from the vessel into a reservoir from which it can be drawn for reuse.

9. A method of treating meat in a vacuum/pressure vessel having means for evacuating the interior of the vessel and means for supplying a preserving gas atmosphere therein, said method comprising the steps of:
a) placing the meat, poultry, or fish in the vessel;
b) closing and sealing the vessel;
c) drawing a vacuum on the vessel;
d) passing a preserving gas into said vessel;
e) after a period of time discontinuing the flow of preserving gas;
f) evacuating the vessel; and
g) allowing the vessel to be filled with atmospheric gases so that the vessel can be opened and unloaded.

10. The method according to claim 9, wherein the preserving gas is a mixture of carbon monoxide and a filler gas, such as nitrogen, reducing gases, inert gases, and mixtures thereof.

11. The method according to claim 9, wherein the preserving gas is evacuated from the vessel into a reservoir from which it can be drawn for reuse.
